(19) United States
(12) Patent Application Publication
(10) Pub. No.: US 2007/0214616 A1
(43) Pub. Date: Sep. 20, 2007

(54) Adjustable length rope clip system

(76) Inventor: Mark Peterson, Braham, MN (US)

Correspondence Address: JANET PEYTON SCHAFER;SCHAFER LAW OFFICE, P.A., 727 TORCHWOOD CIRCLE, NEW BRIGHTON, MN, 55112, US

(21) Appl. No.: 11/512,831

(22) Filed: Aug. 30, 2006

Related U.S. Application Data
(60) Provisional application No. 60/782,442, filed on Mar. 15, 2006.

(51) Int. Cl. F16B 45/02

(52) U.S. Cl. 24/599.1

(57) ABSTRACT

An adjustable length rope clip with a body having a handle end, a hook end and an arm element formed midway between the hook and handle ends which allows a lead rope to be positioned thereon in one of three positions for permitting a predetermined length of rope to be released when pressure is applied, the pressure could result from a horse being tied to a holding location and pulling on the rope. The adjustable length rope clip aids in training the horse from getting spooked while adjusting to the training program.

### BACKGROUND

The present invention is directed generally to animal tying systems. In particular, the present invention relates to a clip, having a arm element for positioning a lead rope or the like on the clip, the positioning of the lead rope on the clip providing means for retaining a predetermined length of rope and permitting it to be selectively released upon application of pressure. A clip system where the clip is installed on the lead rope in one of three positions. A clip system further providing means for re-positioning the attached animal or object without the addition of other devices and without un-tethering the animal or other object, even momentarily.

Animal tying systems have been used previously. Examples of such animal tying systems are:

| Name | Patent No. |
|---|---|
| Luebke et al. | 1,476,627 |
| Nelson | 5,366,327 |
| Blocker | 6,684,613 |

Several U.S. patents describe rope fasteners having stationary arm elements around which rope is wound, including Anderson U.S. Pat. No. 904,747, Finn U.S. Pat. No. 1,714,770, Koch U.S. Pat. No. 2,370,358 and Sova U.S. Pat. No. 2,441,336.

### SUMMARY

The present invention provides an adjustable length rope clip that is installed on a lead rope rather than the clip being installed in a stationary location. The clip stays with the lead rope. The lead rope is knotted at one end preventing the lead rope from being pulled clear through the clip of this device. A rope clip system further provides means for re-positioning the attached animal or object tethered to the rope without the addition of other devices and without un-tethering the animal or other object, even momentarily. The rope clip has a spring clip closing an open side of a hook end of the clip allowing temporary attachment of the clip system to a fixed object. The rope clip has at least one arm element formed on the body thereof for positioning a lead rope, or the like, on the clip. The lead rope is positioned on the rope clip in one of three positions, a first position providing means for retaining a predetermined length of rope and permitting it to be selectively released upon application of pressure. The clip permits slow release of the lead rope upon application of pressure on the lead rope. This results in a system that allows a horse, or other animal, to pull back briefly and thus prevents the horse from getting spooked while adjusting to the training program of the horse. The positioning of the lead rope on the rope clip in a second position requires a relatively greater amount of pressure to release a predetermined length of the lead rope. Such a situation could result from a horse being tied to a holding location, such as a trailer, and falling down putting a great amount of pressure on the lead rope. The slow release of the lead rope in this position prevents the attached horse from being strangled. The positioning of the lead rope on the clip in a third position locks down the lead rope onto the clip to facilitate the attachment of an animal to the fixed object holding the animal secure, as for example when the horse is monitored for shoeing or veterinary examination.

The rope clip system further providing means for re-positioning the attached animal without the addition of other devices and without un-tethering the animal, even momentarily. The animal is lead by the rope clip system, the rope clip on a lead rope, to a new location and the clip re-attached to a different fixed object, such as moving from a cross-tie to a trailer. The clip is mounted or installed on the lead rope and carried with the lead rope, and attached animal or object.

The clip system also is used as a pulley by positioning the clip on a rope, attachment of the clip to a fixed point, then pulling on the rope through the clip to hoist a weighted object to a desired position and locking down the rope. For example, positioning of the clip system, the clip on the rope of a hay net positioned on the clip in the first position as described herein, the clip being attached to a ring in a trailer, the hay net filled while supported by the ground, the rope portion of a hay net is then pulled into position hoisting the heavy filled hay net to a desired location where the loop of the rope portion of the clip system is moved to a locked down position, position three, as described herein.

### BRIEF DESCRIPTION OF THE DRAWINGS

Understanding of the invention will be enhanced by referring to the accompanying drawings, in which like numbers refer to like parts in the several views and in which:

FIG. 1A is a side view of the device of the invention, with a pair of element arms, one each on the dorsal side and distal side of the device;

FIG. 1B is a side perspective view of device of FIG. 1A;

FIG. 1C is a back side view of the device of FIG. 1A;

FIG. 2A is a side view of an embodiment having a single arm element on the side of the device;

FIG. 2B is a side perspective view of the device of FIG. 2A;

FIG. 2C is a back side view of the device of FIG. 2A;

FIG. 3A is a side view of the device of an embodiment having a single arm element on the side of the device and a round handle element;

FIG. 3B is a side perspective view of the device of FIG. 3A;

FIG. 3C is a back side view of the device of FIG. 3A;

FIG. 4A is a side view of the device of the embodiment having;

FIG. 5A is a side view of the device of an embodiment having a flattened arm element, FIG. 5B being the rear side view of this embodiment;

FIG. 6A is a side view of the device of FIG. 3 with a lead rope shown in a position of use where a lesser amount of pressure would need be applied before the lead rope would be released a predetermined length, FIG. 6B being the rear side view of this embodiment;

FIG. 7A is a side view of the device of FIG. 3 with a lead rope shown in a position of use where a greater amount of pressure would need be applied before the lead rope would be released a predetermined length, FIG. 7B being the rear side view of this embodiment; and

FIG. 8A is a side view of the device of FIG. 3 with the lead rope shown in a position of use where the lead rope is in a locked in position, FIG. 8B being the rear side view of this embodiment.

### DETAILED DESCRIPTION OF THE CURRENTLY PREFERRED EMBODIMENTS

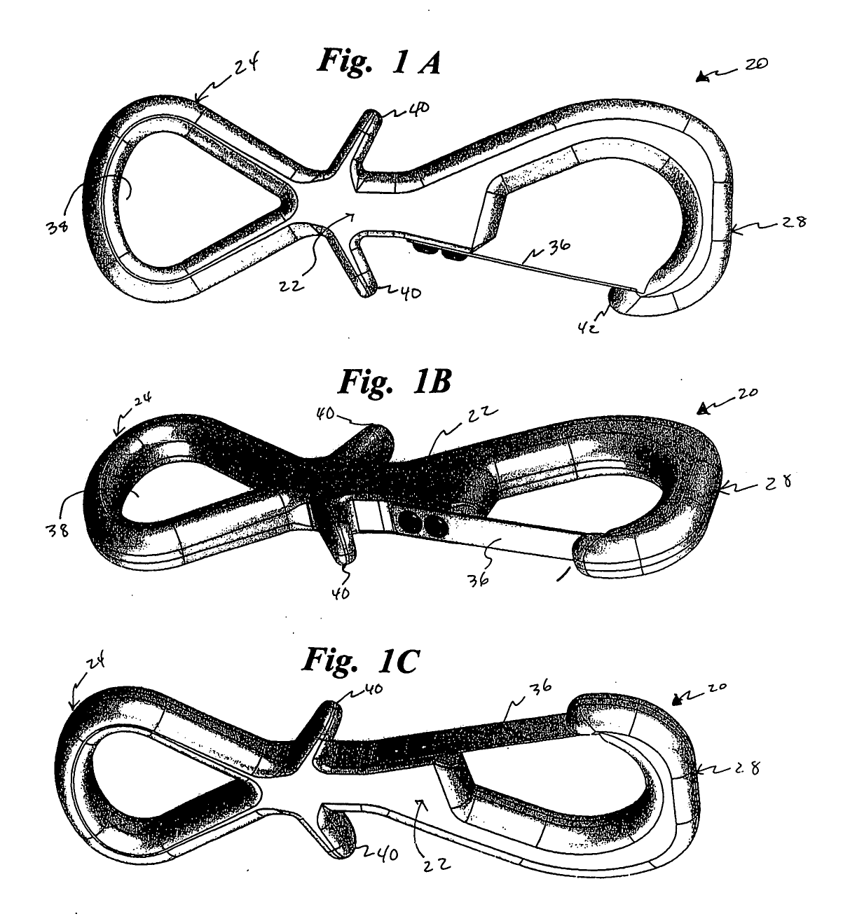

An adjustable length rope clip generally indicated at 20 in FIGS. 1A-C for use with a lead rope or the like as an additional clip on the standard lead rope. The adjustable length rope clip 20 has a spring element 36 closing an open end of a hook end 28, and used as a temporary attachment, of an animal or object tethered by a lead rope, to a fixed object. The adjustable length rope clip 20 also has at least one arm element 40 formed on the body 22 thereof for the positioning of a lead rope or the like on adjustable length rope clip 20. The lead rope is positioned on the adjustable length rope clip 20 in one of three positions, a first position, above the arm element, providing means for retaining a predetermined length of rope and permitting it to be selectively released upon application of pressure. The adjustable length rope clip 20 permits slow release of the rope which prevents the horse from getting spooked while adjusting to the training program of the horse. The lead rope is positioned on the adjustable length rope clip 20 in a second position, below the arm element, where a relatively great amount of pressure is required to release a predetermined length of rope and permitting it to be selectively released. Such a situation could result from a horse being tied to a holding location such as a trailer and falling down putting a great amount of pull on the rope. The slow release prevents the attached horse from being strangled. The lead rope is positioned on the adjustable length rope clip 20 in a third position, the lead rope is looped about the handle of the adjustable length rope clip 20 and locked onto the adjustable length rope clip 20 such as to facilitate the attachment of an animal to the fixed object by a rope lead and the lead rope locked into position holding the animal secure, as for example when the horse is monitored for shoeing or veterinary examination. The present invention provides an adjustable length rope clip that is installed on a lead rope rather than the clip being installed in a stationary location. The clip stays with the lead rope. The lead rope is knotted at one end preventing the lead rope from being pulled clear through the clip of this device. The lead rope may be repositioned on the rope clip without releasing the animal, or other object, from being tethered. So long as pressure is not applied to the lead rope, the rope may be re-positioned between the three positions manually with ease.

The adjustable length rope clip 20 system further providing means for re-positioning the attached animal without the addition of other devices and without un-tethering the animal from the lead rope, even momentarily. The animal is lead by the lead rope in the normal manner with the attached adjustable length rope clip 20 to a new location and the adjustable length rope clip 20 re-attached to a different fixed object, such as moving from a cross-tie to a trailer.

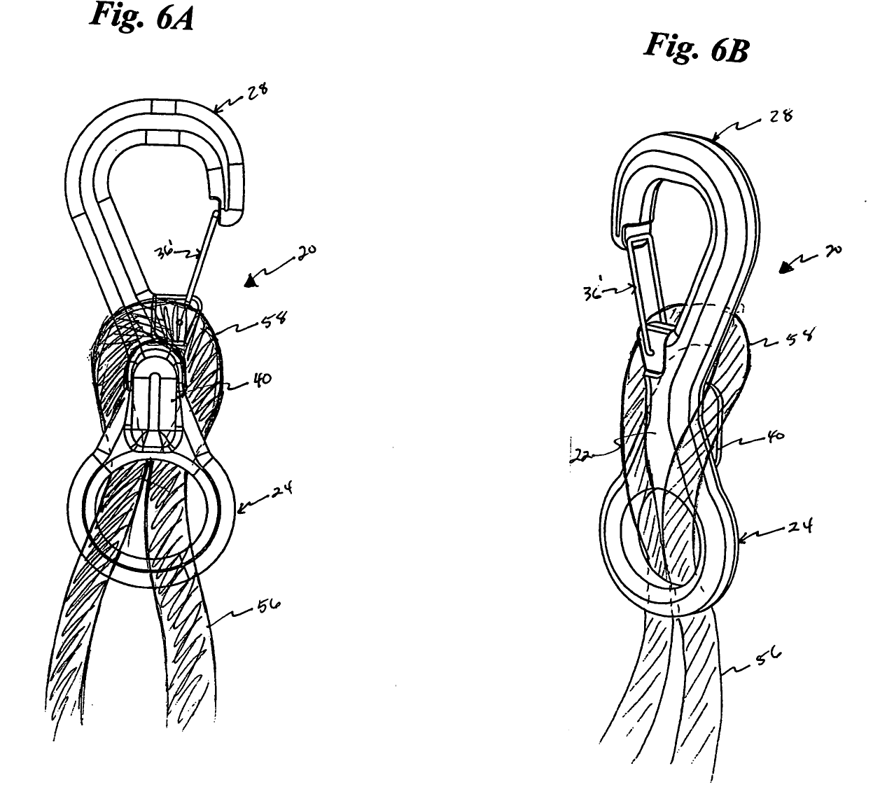

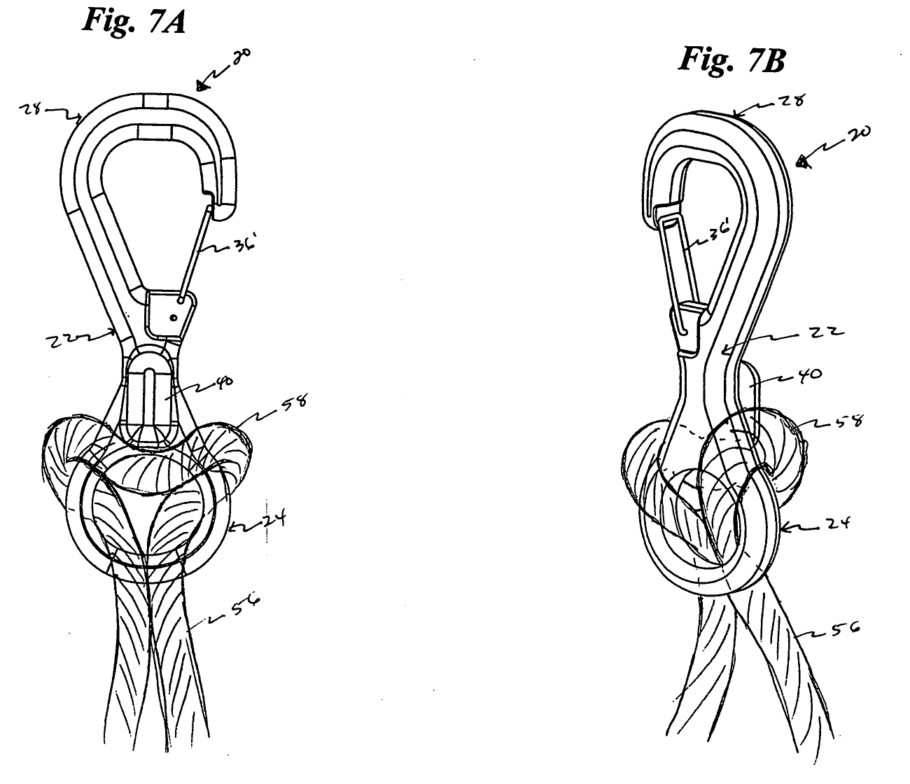

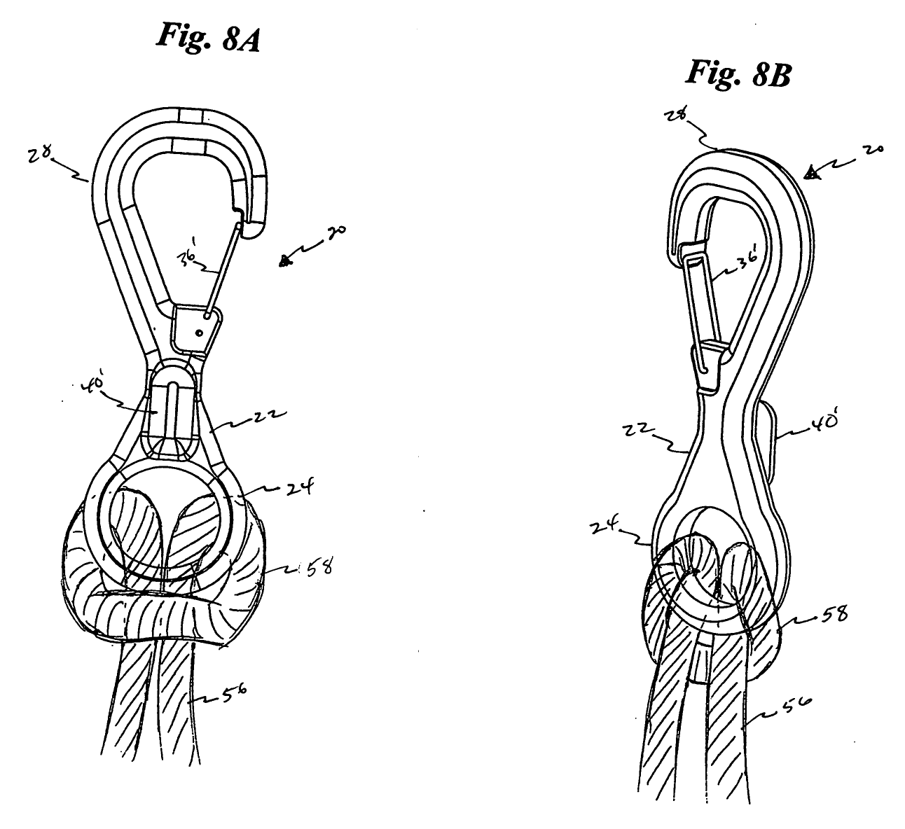

The adjustable length rope clip 20 can be easily re-positioned manually even when there is an animal or other object tethered on the end thereof. A user manually places a loop of the lead rope just above the arm element as shown in FIG. 6 a & 6B, just below the arm element as shown in FIGS. 7A & 7B, or looped around the handle of the adjustable length rope clip 20 as shown in FIGS. 8A & 8B.

A variety of adjustable length rope clips 20 have been tested. Each has a body 22 having a hook end 28, a handle end 24, an arm element 40 mounted on the body 22 midway between the hook end 28 and the handle end 24, and a spring element 36 mounted for use on the hook end 28.

FIG. 1A-FIG. 1C illustrates a device 20 of the invention having a body 22 with a handle 24, a hook end 28, with a pair of arm elements 40 positioned in between, one each on a proximal surface 30 and a distal surface 34 of the device 20. Also shown is a spring element 36. In all embodiments, the body 22 is, in actual use conditions, of aluminum, however other rigid materials including other metals and ceramics could be used. The body 22 of the device is of uniform construction with a spring element 36 mounted thereon. A flat stainless steel spring has been used although other resilient materials could also be used. The spring element 36 is positioned to closed the hook end 28 of the device by catching an end portion of the spring element by a lip 42 formed on the hook end 28, closing the open end of the hook. Handle 24 is shown having a generally triangular shape although other shapes have been used as described hereinafter.

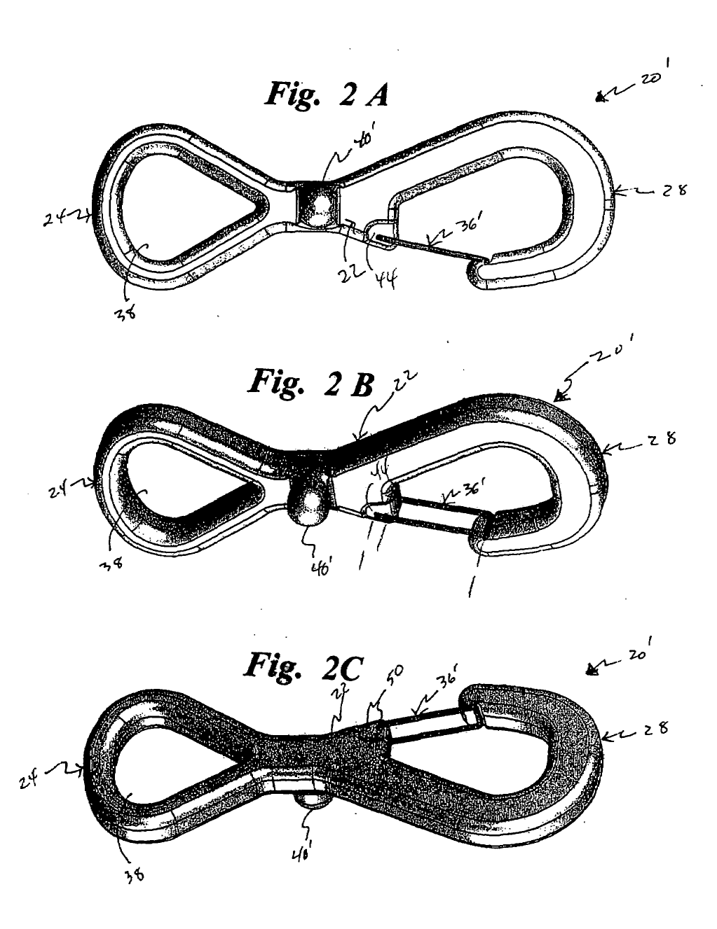

FIG. 2A-FIG. 2C illustrate an embodiment having a single arm element 40 projecting at a right angle from the body 22 on a first lateral surface 46 of the device 20. This embodiment also is of aluminum one-piece construction having a generally triangular shaped handle. The arm element 40 has a rounded shape with a pair of flattened sides one each toward the hook end 28 and toward the handle end 24 of the device 20. The spring element 36′ is a length of round wire of stainless steel shaped generally as a rectangle. The legs 37 of the long sides of the rectangle having different lengths, each leg 37 having a projecting end positioned at a right angle to leg, for receipt by the a pair of bores 50 formed in body 22 at the hook element base 44, shown in detail at FIG. 2C. A pair of bores 50 is formed into both sides of hook element base 44. Each bore 50 receives one leg 37 of the hook spring element 36. One leg of the spring element 36′ is received by upper bore 50, the opposite side receives the opposite leg into a lower bore 50. Because spring element 36′ is positioned on the device with the legs 37 of the long sides of the rectangle having different lengths, each leg 36 having a projecting end positioned at a right angle to leg, for receipt by the a pair of bores 50, the spring element is thereby “pre-loaded” with tension closing the open end of hook element 28 when in its position of use.

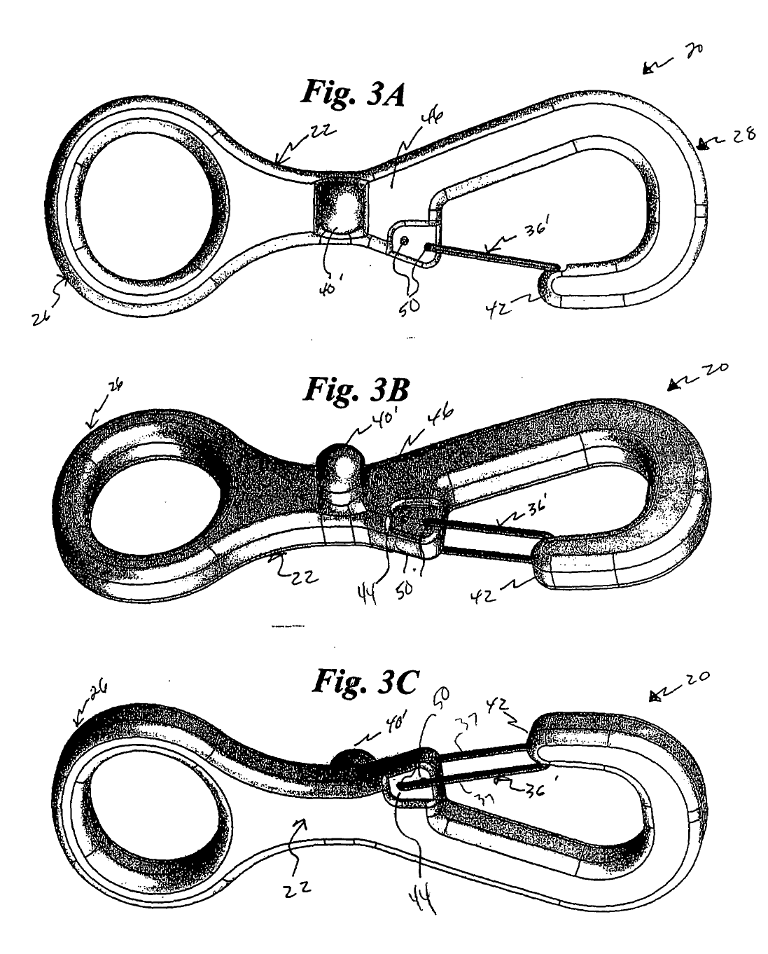

FIGS. 3A-3C illustrate an embodiment having a single arm element 40 projecting at a right angle from the body 22 on a first lateral surface 46 of the device 20. This embodiment also is of aluminum one-piece construction having a generally circular shaped handle. The arm element 40′ has a rounded shape with a pair of flattened sides one each toward the hook end and toward the handle end of the device 20. The spring element 36′ is a round wire length of stainless steel shaped generally as a rectangle. The legs 37 of the long sides of the rectangle having different lengths and each leg 37 having a projecting end for receipt by the a pair of bores 50 formed in body 22 at the hook element base 44, shown in detail at FIG. 2C. Each bore 50 receives one leg of the hook spring element 36′. One leg of the spring element is received by upper bore, opposite side receives the opposite leg into a lower bore. Because spring element 36′ is positioned on the device so that it is slightly bent by abutting hook element 28, the spring element is thereby “pre-loaded” with tension closing the open end of hook element 28 when in its position of use.

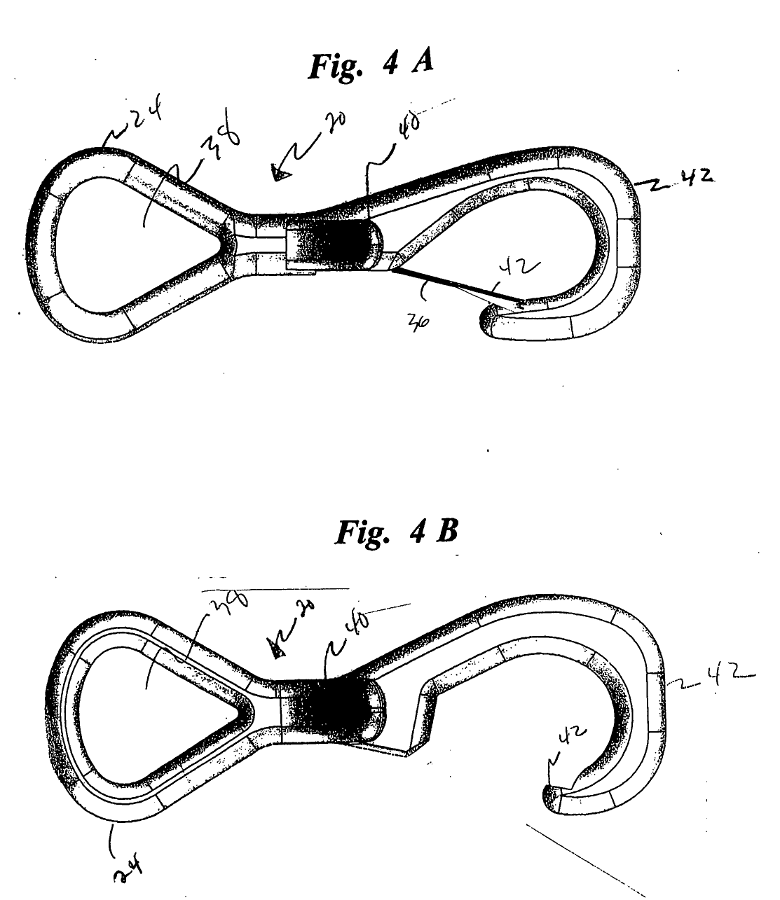

FIG. 4A is an embodiment similar to that in FIGS. 1 A-C except this embodiment has a single arm element 40 on a first lateral surface 46 of the device 20. This embodiment has a triangular shaped handle 24 and a hook end 28 including a steel spring 36′, as described above. FIG. 4B is a side view of the embodiment of FIG. 4A, with a broader single arm element 40.

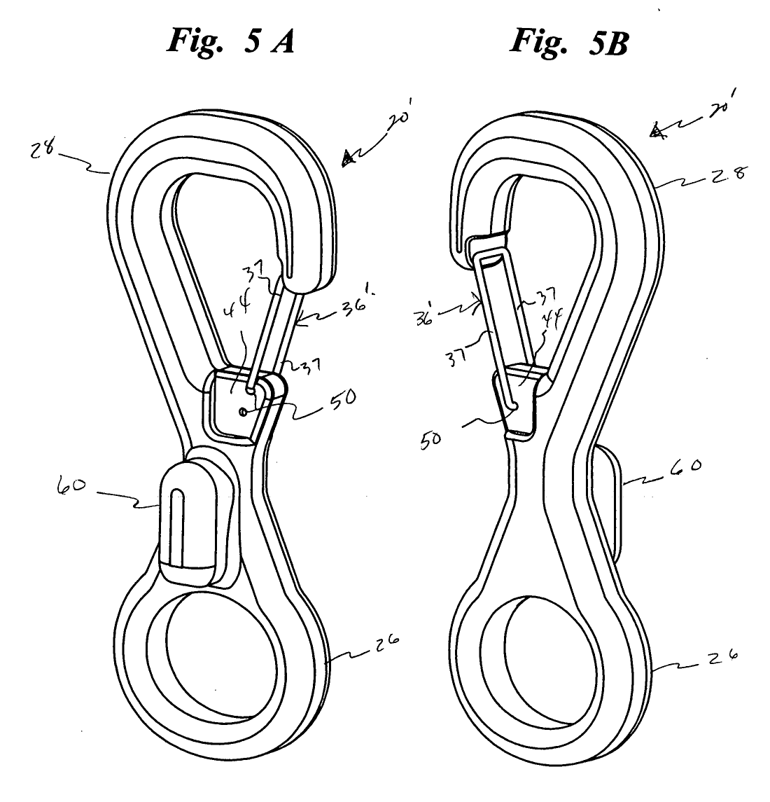

FIG. 5A, similar to FIGS. 2 & 3, has a circular handle, steel spring element 36′, as described above, and a generally oval-shaped arm element 60.

FIGS. 6-8 illustrate use of the device of this invention. All embodiments are of aluminum although other rigid material such as other metals or ceramics could be used. All embodiments are manufactured similarly and have a molded body 22 with a hook end 28 and a handle end 24 with at least one arm element 40 formed approximately in the mid section of the device 20. The handle end 24 of the device is shown with a generally triangular shape or a generally rounded shape. Both shaped handles have an opening formed therein for receipt of a loop of the lead rope 56. It is noted that the devices shown at FIGS. 1, 2& 4 could utilize a rounded handle end. For example, FIG. 3 illustrates the device of FIG. 2B with a rounded handle end.

FIG. 6 is a side view of the device of FIG. 2 in a first position, although all embodiments perform similarly, with a portion of a lead rope 56 shown positioned above the arm element 40 where pressure would need be applied before the lead rope 56 would be released a predetermined length. The lead rope 56 receives a knot at an end opposite the lead rope shank that connects to the animal in the normal manner. In use, a portion of the lead rope 56 is looped through the opening 38 in the handle end 24 of the device, this loop of the lead rope 56 is positioned above the arm element and held in place by frictional forces. The animal attached to the lead rope is tethered to a fixed position by means of fastening the hook end 28 of the device 20 over a fixed loop, picket line or other anchoring device.

When the lead rope 56 is positioned in the second position, as illustrated at FIG. 7A & B, a relatively large amount of pressure is applied, by the animal backing up strongly or pulling downwardly as in a fall, and pulls the lead rope 56 out slowly a pre-determined length, the lead rope 56 stopped by a knot formed in the end thereof, permitting the animal to get away from the fright without breaking the lead rope or the halter. The arm element 40 holds the lead rope in this selected second position.

When the lead rope 56 is positioned in a third position, as shown in FIG. 8 A & B, a side view of the device of FIG. 2 with a lead rope 56 shown in a position of use where the lead rope 56 is looped around handle 26 and the lead rope is locked in position. An important feature is that the lead rope 56 may be positioned in any of the three positions shown at FIGS. 6, 7 & 8 by moving the loop of the lead rope 56 between the three positions. This repositioned of the lead rope may be done without releasing the animal, or other object, from being tethered. So long as pressure is not applied to the lead rope, the rope may be re-positioned manually with ease. The apparatus would allow the securing device to detach from the fixed object while maintaining attachment to the animal for moving the animal to a different location. A user may tether an animal to a fixed object by releasing the spring element 36 freeing the hook end 28 from the fixed loop or other object and leading the animal to a new position, example in a trailer, without having to removing the lead rope from the animal or attaching another lead rope to the animal.

In use, the animal is mounted or installed on a lead rope, a loop 58 is made in the mid-way on the lead rope, the loop 58 pushed through an opening 38 in the handle 24 of device 20 from front to back. The loop 58 is slipped over the hook end 28, and pulled down about the arm element in one of three positions, as described above, resulting in the loop 58 being on the same side of the device 20 as the lead rope entering the opening 38 of device 20, as shown in FIGS. 6-8.

When the attached animal is tethered to the device 20 with the lead rope loop is in the first position, positioned above the arm element, the length of the lead rope may be adjusted by manually pulling on the lead rope end opposite the attached animal to shorten the amount of lead rope available to the animal, shown at FIGS. 6 A & 6B. When the lead rope is thus positioned, some pressure must be applied to adjust the lead rope length, either to increase the amount of lead rope available or to decrease the amount of lead rope available to the animal. Even when the rope is pulled tight with weight on the lead rope, the lead rope does not tighten into a knot. Removal is still easy. Pressure is released and the loop manually repositioned on the rope clip.

When the animal is tethered by means of the rope clip to a fixed object, the rope clip can be detached from the fixed object with the animal still attached to the rope clip by lead rope and the animal may be lead to a new site and tethered by means of the rope clip anew without having to detach the animal from the lead rope at any time, as shown at FIGS. 8A & 8B. The new site can be a trailer, a picket, new cross-tie position, etc. Unless the animal is monitored, it is preferred to put the lead rope in the second position on the rope clip. Other devices such as a boat on the water, an ATV or other objects could be tethered in this manner to a fixed position yet easily untethered and removed to a new site without releasing the object. The clip system also is used as a pulley by positioning the clip on a rope, attachment of the clip to a fixed point, then pulling on the rope through the clip to hoist a weighted object to a desired position and locking down the rope. For example, positioning of the clip system, the clip on the rope of a hay net positioned on the clip in the first position as described herein, the clip being attached to a ring in a trailer, the hay net filled while supported by the ground, the rope portion of a hay net is then pulled into position hoisting the heavy filled hay net to a desired location where the loop of the rope portion of the clip system is moved to a locked down position, position three, as described herein.

Although the present invention has been described in considerable detail with reference to certain preferred versions thereof, workers skilled in the art will recognize that changes maybe made in form and detail without departing from the spirit and scope of the invention.

What is claimed is:

1. An adjustable length rope clip for use with an animal on a lead rope, comprising:
a) a body, of uniform construction, having a handle portion formed in one end and a hook portion formed in the opposite end, said hook portion having an open end;
b) a spring clip, attached to the hook portion of said body, said spring clip closing said open end of said hook portion, for temporary attachment of the animal on a lead rope to a fixed object;
c) at least one arm element, formed mid way of said body, to position the lead rope relative to the apparatus and yet permit the automatic release of a predetermined length of lead rope upon application of pressure upon the lead rope;
d) means for detaching said rope clip from the fixed object, while maintaining attachment of the lead rope to the animal, for moving the attached animal to a different location.

2. The apparatus of claim 1, wherein said handle portion of said body further comprises a generally triangular shaped opening.

3. The apparatus of claim 1, wherein said handle portion of said body further comprises a generally round shaped opening.

4. The apparatus of claim 1, wherein said spring clip is a steel spring clip.

5. The apparatus of claim 1, wherein said spring clip is a round wire length of stainless steel spring shaped generally as a rectangle, the legs of the long sides of the rectangle having different lengths and each leg having a projecting end for receipt by a pair of bores formed in said body of the apparatus.

6. The apparatus of claim 5, wherein said a pair of bores formed in said body of the apparatus, because said pair of bores are formed in a line on a hook base, said bores receiving projecting ends of said legs of said steel spring, they further comprise means to pre-load said spring such that said spring is pressured to close against a hook end lip of said hook portion closing an open end of said clip hook end.

7. The apparatus of claim 1, wherein said arm element further comprises a flattened projection extending upwardly at an angle midway between said handle portion and hook portion and providing means for selectively positioning a rope thereon.

8. The apparatus of claim 1, wherein said arm element further comprises a generally rounded shaped arm with a pair of flattened sides, one each toward said hook end and one toward said handle end of the apparatus.

9. The apparatus of claim 1, wherein said arm element further comprises a generally oval shaped arm element for positioning a lead rope relative to said apparatus.

10. The apparatus of claim 1, wherein positioning a lead rope in a first position, with a lead rope loop above said arm element, further comprises means for automatic release of a length of a lead rope upon application of a generally lesser amount of pressure to the lead rope.

11. The apparatus of claim 1, wherein positioning a lead rope in a second position, with the lead rope loop below said arm element, further comprises means for automatic release of a length of lead rope upon application of a generally greater amount of pressure to the lead rope.

12. The apparatus of claim 1, wherein positioning a lead rope in said third position, the lead rope looped about said handle, further provides means for locking a lead rope attached to said apparatus preventing movement of the lead rope through said clip.

13. The apparatus of claim 1, wherein a lead rope may be re-positioned in any of the three positions, so long as pressure is not applied to the lead rope, the rope may be re-positioned manually with ease.

14. An adjustable length rope clip for use with an animal or object on a lead rope, the rope clip installed on the lead rope, the rope clip comprising:
a) a body, of uniform construction, having a handle portion formed in one end and a hook portion formed in the opposite end of said body, said hook portion having an open end;
b) a spring clip, attached to a hook base of said hook portion of said body, said spring clip closing said open end of said hook portion, for temporary attachment of the rope clip to a fixed object, the animal or object on the lead rope following;
c) an arm element formed midway of said body to position a loop of the lead rope relative to said rope clip in one of three positions, a first position with the loop above said arm element, a second position with the loop below said arm element and a third position with the loop about said handle portion of said clip.

15. The apparatus of claim 14, wherein positioning a lead rope in a first position, with a lead rope loop above said arm element, further comprises means for automatic release of a length of a lead rope upon application of a generally lesser amount of pressure to the lead rope.

16. The apparatus of claim 14, wherein positioning a lead rope in a second position, with the lead rope loop below said arm element, further comprises means for automatic release of a length of lead rope upon application of a generally greater amount of pressure to the lead rope.

17. The apparatus of claim 14, wherein positioning a lead rope in said third position, the lead rope looped about said handle, further provides means for locking a lead rope attached to said apparatus preventing movement of the lead rope through said clip.

18. A method of using an adjustable length rope clip, for use as a pulley for lifting heavy objects, further comprising the steps of:
a) positioning the apparatus of claim 1 on a rope with a loop of the rope above a clip arm element;
b) attaching the clip to a fixed point;
c) pulling on the rope through the clip to hoist a weighted object to a desired position; and
d) locking down the rope by re-positioning said loop of said rope about a handle portion of said clip.
